(19) United States
(12) Patent Application Publication
(10) Pub. No.: US 2025/0273115 A1
(43) Pub. Date: Aug. 28, 2025

(54) DISPLAY APPARATUS USING DITHER MASK AND CONTROL METHOD THEREOF

(71) Applicant: SAMSUNG ELECTRONICS CO., LTD., Suwon-si (KR)

(72) Inventors: Jiyong PARK, Suwon-si (KR); Younghoon CHO, Suwon-si (KR); Joohyun LEE, Suwon-si (KR); Seongkoo CHEONG, Suwon-si (KR)

(73) Assignee: SAMSUNG ELECTRONICS CO., LTD., Suwon-si (KR)

(21) Appl. No.: 19/209,149

(22) Filed: May 15, 2025

Related U.S. Application Data
(63) Continuation of application No. PCT/KR2023/019878, filed on Dec. 5, 2023.

(30) Foreign Application Priority Data
Dec. 15, 2022 (KR) 10-2022-0176329

(51) Int. Cl. G09G 3/20; G09G 3/32

(52) U.S. Cl. CPC G09G 3/2044; G09G 3/32; G09G 2300/026; G09G 2300/06; G09G 2320/0247

(57) ABSTRACT

A display apparatus includes a display panel including a plurality of display modules, one or more processors including processing circuitry, and memory storing instructions. The instructions, when executed by the one or more processors individually or collectively, cause the display apparatus to display, using the display panel, an image including a plurality of image frames, and display, on each display module of the plurality of display modules, a dither mask from among a plurality of dither masks corresponding to an image frame of the plurality of image frames. Each display module of the plurality of display modules is configured to receive the image frame of the plurality of image frames, identify, based on receipt of the image frame, the dither mask corresponding to the image frame, and display a partial image corresponding to the image frame and the dither mask.

### CROSS-REFERENCE TO RELATED APPLICATIONS

This application is a continuation application of International Application No. PCT/KR2023/019878, filed on Dec. 5, 2023, which claims priority to Korean Patent Application No. 10-2022-0176329, filed on Dec. 15, 2022, in the Korean Intellectual Property Office, the disclosures of which are incorporated by reference herein in their entireties.

### BACKGROUND

### 1. Field

The present disclosure relates generally to a display apparatus and a control method thereof, and more particularly, to a display apparatus that applies a dither mask to an image frame, and a control method thereof.

### 2. Description of Related Art

Recently, there may be a trend to develop and distribute display apparatuses in various forms. For example, display apparatuses having relatively bigger sizes and/or having relatively higher resolutions may be more common, and as a consequence, the number of display modules constituting the display apparatuses may also be increasing.

The display apparatuses may be operated by using a passive matrix (PM) method in an attempt to reduce and/or manage factors such as, but not limited to, luminance, cost, or the like of the display apparatuses. However, the PM method may provide for a minimum light emission amount that may be higher than a similar display apparatus operating by using an active matrix (AM) method. Consequently, various dither methods may be used on the display apparatuses operated by using the PM method to attempt to address these apparent deficiencies.

For example, a temporal dither method may be at least one of various dither methods that may be used on the display apparatuses. However, the temporal dither method may generate flicker while the display apparatus is being driven, as well as, other potentially undesirable effects.

Thus, there exists a need for further improvements in display apparatus technology, as the need for relatively bigger sizes and/or relatively higher resolutions may be constrained by temporal dither methods used in display apparatuses operating by a PM method. Improvements are presented herein. These improvements may also be applicable to other display apparatus technologies.

### SUMMARY

According to an aspect of the present disclosure, a display apparatus includes a display panel including a plurality of display modules, one or more processors including processing circuitry, and memory storing instructions. The instructions, when executed by the one or more processors individually or collectively, cause the display apparatus to display, using the display panel, an image including a plurality of image frames, and display, on each display module of the plurality of display modules, a dither mask from among a plurality of dither masks corresponding to an image frame of the plurality of image frames. Each display module of the plurality of display modules is configured to receive the image frame of the plurality of image frames, identify, based on receipt of the image frame, the dither mask corresponding to the image frame, and display a partial image corresponding to the image frame and the dither mask.

According to an aspect of the present disclosure, a control method to by performed by a display apparatus includes displaying, using a display panel including a plurality of display modules of the display apparatus, an image including a plurality of image frames, and displaying, on each display module of the plurality of display modules, a dither mask from among a plurality of dither masks corresponding to an image frame of the plurality of image frames. The displaying of the dither mask includes receiving, by each display module of the plurality of display modules, the image frame of the plurality of image frames, identifying, by each display module of the plurality of display modules, the dither mask corresponding to the image frame, based on the receiving of the image frame, and displaying, by each display module of the plurality of display modules, a partial image corresponding to the image frame and the dither mask.

According to an aspect of the present disclosure, a non-transitory computer-readable storage medium stores a computer-executable program for executing a control method. The computer-executable program, when executed by at least one processor of a display apparatus, causes the display apparatus to display, using a display panel of the display apparatus, an image including a plurality of image frames, the display panel including a plurality of display modules, and display, on each display module of the plurality of display modules, a dither mask from among a plurality of dither masks corresponding to an image frame of the plurality of image frames. The computer-executable program, when executed by the at least one processor, further cause the display apparatus to receive, by each display module of the plurality of display modules, the image frame of the plurality of image frames, identify, by each display module of the plurality of display modules, the dither mask corresponding to the image frame, based on the receiving of the image frame, and display, by each display module of the plurality of display modules, a partial image corresponding to the image frame and the dither mask.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram for illustrating a display apparatus displaying an image, according to an embodiment of the disclosure;

FIG. 2 is a diagram for illustrating a display apparatus wherein a plurality of display modules are combined, according to an embodiment of the disclosure;

FIG. 3 is a block diagram for illustrating a display apparatus, according to an embodiment of the disclosure;

FIG. 4 is a diagram for illustrating dither masks, according to an embodiment of the disclosure;

FIG. 5 is a diagram for illustrating flickers due to dither masks, according to an embodiment of the disclosure;

FIG. 6 is a diagram for illustrating a reference signal, according to an embodiment of the disclosure; and

FIG. 7 is a flow chart for illustrating a control method of a display apparatus, according to an embodiment of the disclosure.

### DETAILED DESCRIPTION

First, terms used in the present disclosure are described briefly, and then the disclosure is described.

As used herein, general terms that may currently be widely used may have been selected as far as possible, in consideration of the functions described in the present disclosure. However, the terms may vary depending on the intention of those skilled in the art, previous court decisions, or emergence of new technologies, or the like. Also, in particular cases, there may be terms that may have been arbitrarily designated by the applicant, and in such cases, the meaning of the terms may be described in the relevant descriptions in the present disclosure. Accordingly, the terms used in the present disclosure may be defined based on the meaning of the terms and the overall content of the present disclosure, but not just based on the names of the terms.

It is to be understood that various modifications may be made to embodiments of the present disclosure, and that there may be various types of embodiments. Accordingly, examples of embodiments are illustrated in drawings, and the examples of the embodiments are described in the present disclosure. However, it is to be understood that the various embodiments are not for limiting the scope of the present disclosure to the disclosed embodiments, but the disclosed embodiments should be interpreted to include all modifications, equivalents, or alternatives of the disclosed embodiments included in the ideas and the technical scopes disclosed herein. In addition, in case it is determined that in describing embodiments, a detailed explanation of related known technologies may confuse the gist of the disclosure, the detailed explanation may be omitted.

In addition, terms such as “first,” “second,” and the like may be used to describe various elements, but the terms are not intended to limit the elements. Such terms are used only to distinguish one element from another element. The terms “upper,” “middle”, “lower”, and the like may be replaced with terms, such as “first,” “second,” third” to be used to describe relative positions of elements.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

Further, singular expressions include plural expressions, unless defined differently in the context. Also, in the present disclosure, terms such as “include” or “consist of” should be construed as designating that there are such characteristics, numbers, steps, operations, elements, components, or a combination thereof described in the present disclosure, but not as excluding in advance the existence or possibility of adding one or more of other characteristics, numbers, steps, operations, elements, components, or a combination thereof.

In addition, in the present disclosure, “a module” or “a part” may perform at least one function or operation, and may be implemented as hardware, software, or as a combination of hardware and software. Also, a plurality of “modules” or “parts” may be integrated into at least one module and implemented as at least one processor, except “a module” or “a part” that may need to be implemented as specific hardware.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings, such that those having ordinary skill in the art to which the disclosure belongs may carry out the disclosure. However, it should be noted that the disclosure may be implemented in various different forms, and is not limited to the embodiments described herein. Also, in the drawings, parts that are not related to explanation were omitted, for explaining the disclosure clearly, and throughout the present disclosure, similar components were designated by similar reference numerals.

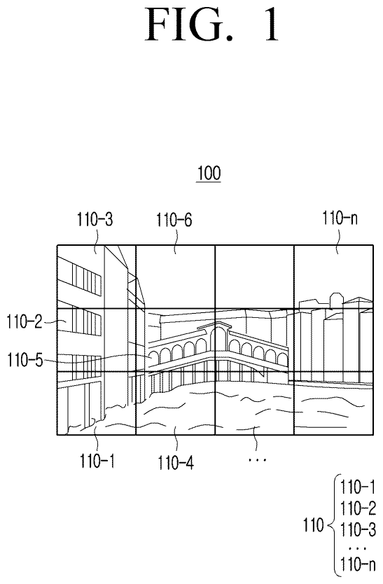

FIG. 1 is a diagram for illustrating a display apparatus displaying an image, according to an embodiment of the disclosure.

Referring to FIG. 1, the display apparatus 100 may consist of a plurality of display modules (e.g., a first display module 110-1, a second display module 110-2, a third display module 110-3, to an n-th display module 110-n, where n is a positive integer greater than one (1)). The display apparatus 100 may display video data. The display apparatus 100 may be implemented as a television (TV). However, the present disclosure is not limited thereto, and any apparatus equipped with a display function such as, but not limited to, a video wall, a large format display (LFD), digital signage, a digital information display (DID), a projector display, or the like. Alternatively or additionally, the display apparatus 100 may be implemented as displays in various forms such as, but not limited to, a liquid crystal display (LCD), organic light-emitting diodes (OLEDs), liquid crystal on silicon (LCOS), digital light processing (DLP), a quantum dot (QD) display panel, quantum dot light-emitting diodes (QLEDs), or the like.

According to an embodiment, the display apparatus 100 may be implemented as a form of a modular display including a plurality of first to n-th display modules 110-1 to 110-n.

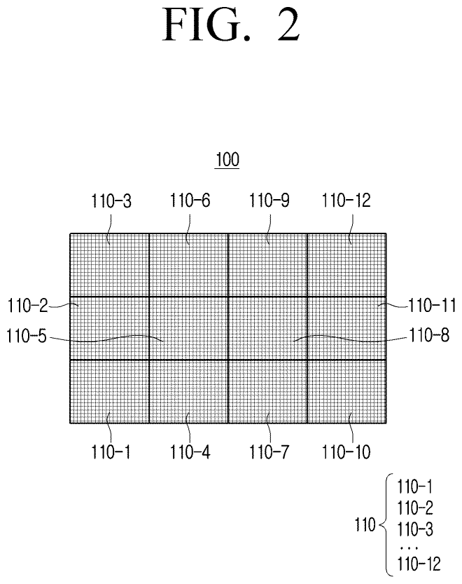

FIG. 2 is a diagram for illustrating a display apparatus wherein a plurality of display modules are combined, according to an embodiment of the disclosure.

For example, as illustrated in FIG. 2, the plurality of display modules (e.g., a first display module 110-1, a second display module 110-2, a third display module 110-3, a fourth display module 110-4, a fifth display module 110-5, a sixth display module 110-6, a seventh display module 110-7, an eighth display module 110-8, a ninth display module 110-9, a tenth display module 110-10, an eleventh display module 110-11, and a twelfth display module 110-12) may be combined and implement one (1) display apparatus (e.g., the display apparatus 100).

Each display module of the plurality of first to n-th display modules 110-1 to 110-n, according to an embodiment of the disclosure, may include a plurality of self-emitting diodes. For example, the self-emitting diodes may be at least one of light-emitting diodes (LEDs), micro LEDs, or the like.

Each display module of the plurality of first to n-th display modules 110-1 to 110-n may be implemented as an LED cabinet including a plurality of light-emitting diodes (LEDs). The plurality of LEDs may be implemented in various forms such as, but not limited to, red/green/blue (RGB) LEDs, which may include a red LED, a green LED, and a blue LED. Alternatively or additionally, the LEDs may include LEDs with various colors, such as, but not limited to, a white LED.

According to an embodiment, the plurality of LEDs may be implemented as micro LEDs. As used herein, micro LEDs may refer to LEDs having a size of about 5 micrometers (μm) to about 100 μm. In addition, the micro LEDs may be and/or may include micro-mini light emitting elements emitting light by themselves without a color filter.

According to an embodiment, each display module of the plurality of first to n-th display modules 110-1 to 110-n included in the display apparatus 100 may be connected with each other. For example, at least one display module (e.g., the first display module 110-1) may receive a control signal, video data, or the like from an external apparatus (e.g., a source apparatus) and may transmit the received control signal, video data, or the like to another display module (e.g., the second display module 110-2) that may be serially connected to the at least one display module. Accordingly, the control signal, the video data, or the like may be sequentially transmitted to all the display modules of the plurality of first to n-th display modules 110-1 to 110-n.

As another example, the display apparatus 100 may include at least one processor, which may be configured to, based on location information of each display module of the plurality of first to n-th display modules 110-1 to 110-n, transmit a control signal, video data, or the like corresponding to the locations to each display module of the plurality of first to n-th display modules 110-1 to 110-n. Accordingly, the display apparatus 100 may output an image corresponding to the video data received from the external apparatus.

According to an embodiment, each display module of the plurality of first to n-th display modules 110-1 to 110-n may operate by using a passive matrix method.

As used herein, the passive matrix method may refer to a method in which at least one driver integrated circuit (IC) may sequentially provide a scan signal to a plurality of scan lines, and the at least one driver IC may apply data to pixels corresponding to a scan line to which the scan signal is provided from among the plurality of scan lines by using a plurality of data lines.

In an embodiment, a minimum light emission amount of LEDs, operating according to the passive matrix method, may be relatively higher than a minimum light emission amount of LEDs, operating according to an active matrix method.

Consequently, the display apparatus 100, when operating according to the passive matrix method, may dither an image by using a dither mask in order to potentially reduce the minimum light emission amount of the LEDs, and subsequently output the image.

According to an embodiment, dithering may include temporal dithering and/or static dithering.

As used herein, temporal dithering may refer to alternatingly outputting a relatively bright pixel and a relatively dark pixel in units of image frames. For example, the display apparatus 100 may perform dithering in a first image frame by using a first dither mask, and perform dithering in a second image frame by using a second dither mask.

According to an embodiment, when each display module of the plurality of first to n-th display modules 110-1 to 110-n may dither an image frame by using a different dither mask in the same image frame and then outputs the frame, frequency fluctuation within the dithered image frame may increase and/or may be relatively large, and/or frequency fluctuation between image frames may increase and/or may be relatively large. That is, a flicker phenomenon may be generated when a plurality of image frames are output.

For example, if the first display module 110-1 performs dithering by using the first dither mask, and the second display module 110-2 performs dithering by using the second dither mask in the first image frame, a flicker phenomenon (e.g., flickering of some areas within the image frame, and/or flickering of some areas when the image frame is converted) may be generated while the first image frame is being output.

Accordingly, each display module of the plurality of first to n-th display modules 110-1 to 110-n, according to an embodiment of the disclosure, may dither an image frame by using the same dither mask in units of image frames, and subsequently output the frame.

For example, each of the first display module 110-1 and the second display module 110-2 may perform dithering by using the first dither mask in the first image frame, and each of the first display module 110-1 and the second display module 110-2 may perform dithering by using the second dither mask in the second image frame. Accordingly, a flicker phenomenon may not be generated while the display apparatus 100 outputs a plurality of image frames, and as a result, grayscale linearity may be improved, when compared to related display apparatuses.

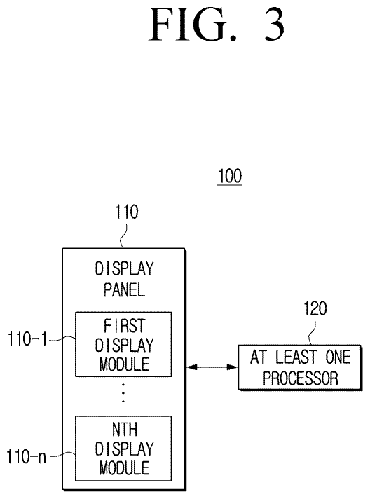

FIG. 3 is a block diagram for illustrating a configuration of a display apparatus, according to an embodiment of the disclosure.

According to FIG. 3, the display apparatus 100 includes a display panel 110 and at least one processor 120.

The display panel 110, according to an embodiment, includes a plurality of display modules (e.g., the first display module 110-1, to the n-th display module 110-n). Each display module of the plurality of first to n-th display modules 110-1 to 110-n may include, for example, a controller (e.g., a timing controller (TCON)).

According to an embodiment, the controller may control overall operations of a corresponding display module.

For example, the controller may sequentially receive a plurality of image frames and reference signals corresponding to each image frame of the plurality of image frames from the at least one processor 120 included in the display apparatus 100.

The controller may identify a dither mask corresponding to the reference signal from among the plurality of dither masks, and control a corresponding display module to dither an image frame by using the identified dither mask, and then output the frame.

The at least one processor 120, according to an embodiment of the disclosure, may control the overall operations of the display apparatus 100.

According to an embodiment of the disclosure, the at least one processor 120 may be implemented as a digital signal processor (DSP) processing digital signals, a microprocessor, and/or a timing controller (TCON). However, the present disclosure is not limited thereto, and the at least one processor 120 may be and/or may include one or more of a central processing unit (CPU), a micro controller unit (MCU), a micro processing unit (MPU), a controller, an application processor (AP) or a communication processor (CP), an advanced reduced instruction set computer (RISC) machine (ARM) processor, an artificial intelligence (AI) processor, or the like. Alternatively or additionally, the at least one processor 120 may be implemented as a system on chip (SoC) having a processing algorithm stored therein or large scale integration (LSI), or in the form of a field programmable gate array (FPGA). The at least one processor 120 may perform various functions by executing computer executable instructions stored in the memory.

The at least one processor 120 may be and/or may include one or more of a CPU, a graphics processing unit (GPU), an accelerated processing unit (APU), a many integrated core (MIC), a DSP, a neural processing unit (NPU), a hardware accelerator, a machine learning accelerator, or the like. The at least one processor 120 may control one or a random combination of the other components of the display apparatus 100, and perform at least one operation related to communication and/or data processing. Additionally or additionally, the at least one processor 120 may execute one or more programs or instructions stored in the memory. For example, the at least one processor 120 may perform the method, according to an embodiment of the disclosure, by executing the one or more instructions stored in the memory.

In case the method, according to an embodiment of the disclosure, includes a plurality of operations, the plurality of operations may be performed by one processor, or performed by a plurality of processors, individually or collectively. For example, when a first operation, a second operation, and a third operation are performed by the method, according to an embodiment, all of the first operation, the second operation, and the third operation may be performed by a first processor, and/or the first operation and the second operation may be performed by the first processor (e.g., a generic-purpose processor), and the third operation may be performed by a second processor (e.g., an artificial intelligence-dedicated processor).

The at least one processor 120 may be implemented as a single core processor including one core, or may be implemented as one or more multicore processors including a plurality of cores (e.g., multicores of the same kind or multicores of different kinds). In case the at least one processor 120 is implemented as multicore processors, each core of the plurality of cores included in the multicore processors may include internal memory of the processor such as, but not limited to, cache memory, on-chip memory, or the like, and/or a common cache shared by the plurality of cores may be included in the multicore processors. In addition, each core of the plurality of cores (or some of the plurality of cores) included in the multicore processors may independently read a program instruction for implementing the method, according to an embodiment of the disclosure, and perform the instruction, or the plurality of entire cores (or some of the cores) may be linked with one another, and read a program instruction for implementing the method, according to an embodiment of the disclosure, and perform the instruction.

In case the method, according to an embodiment of the disclosure, includes a plurality of operations, the plurality of operations may be performed by one core from among the plurality of cores included in the multicore processors, or they may be performed by the plurality of cores. For example, when the first operation, the second operation, and the third operation are performed by the method, according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In embodiments of the disclosure, the at least one processor 120 may refer to a system on chip (SoC) wherein at least one processor 120 and other electronic components are integrated, a single core processor, a multicore processor, or a core included in the single core processor or the multicore processor. In addition, the core may be implemented as a CPU, a GPU, an APU, a MIC, a DSP, an NPU, a hardware accelerator, or a machine learning accelerator, or the like. However, the present disclosure is not limited thereto.

The at least one processor 120, according to an embodiment of the disclosure, may control the display panel 110 to display an image including a plurality of image frames.

According to an embodiment, the at least one processor 120 may control each display module of the plurality of first to n-th display modules 110-1 to 110-n to display dither masks corresponding to each image frame of the plurality of image frames.

For example, the at least one processor 120 may sequentially transmit the plurality of image frames and reference signals corresponding to each image frame of the plurality of image frames to each display module of the plurality of first to n-th display modules 110-1 to 110-n.

The reference signals may correspond to information on the number of times that the at least one processor 120 may have transmitted the image frames to each display module of the plurality of first to n-th display modules 110-1 to 110-n.

For example, the at least one processor 120 may include a frame counter, and count the number of transmission of image frames by using the frame counter while transmitting a plurality of image frames constituting an image to each display module of the plurality of first to n-th display modules 110-1 to 110-n. The at least one processor 120 may transmit the image frames and the reference signals including the number of transmission corresponding to the image frames to each display module of the plurality of first to n-th display modules 110-1 to 110-n.

When the reference signals are received, each display module of the plurality of first to n-th display modules 110-1 to 110-n may identify a dither mask corresponding to the reference signal from among the plurality of dither masks, may dither the received image frame by using the identified dither mask, and may output the frame.

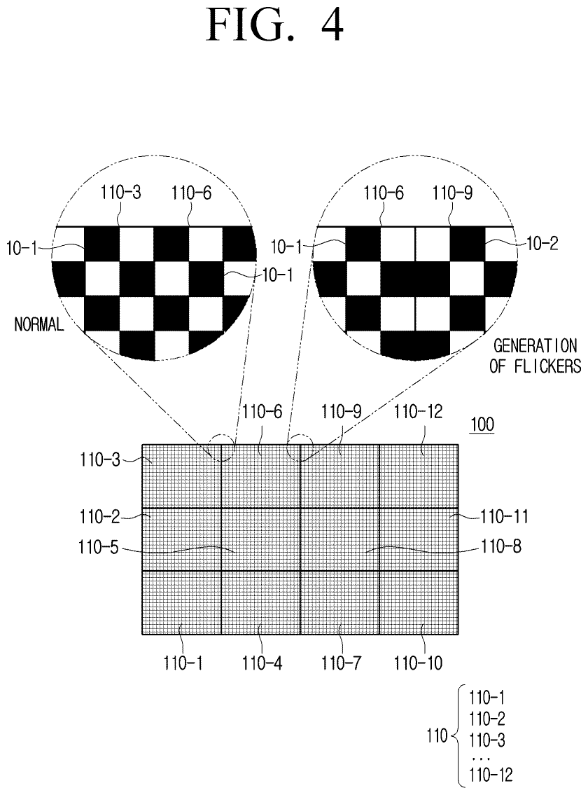

FIG. 4 is a diagram for illustrating dither masks, according to an embodiment of the disclosure.

Referring to FIG. 4, according to an embodiment, the third display module 110-3 from among the plurality of first to n-th display modules 110-1 to 110-n may perform dithering by using the first dither mask 10-1, and the sixth display module 110-6 adjacent to the third display module 110-3 may also perform dithering by using the first dither mask 10-1.

In contrast, the sixth display module 110-6 may perform dithering by using the first dither mask 10-1, and the ninth display module 110-9 adjacent to the sixth display module 110-6 may perform dithering by using the second dither mask 10-2.

If the plurality of first to n-th display modules 110-1 to 110-n perform dithering by using different dither masks, and not the same dither mask, flickers may be generated on the boundaries among the display modules. Referring to FIG. 4, the sixth display module 110-6 and the ninth display module 110-9 may perform dithering by using different dither masks, and thus frequency fluctuation may increase and/or be relatively large on the boundary between the sixth display module 110-6 and the ninth display module 110-9, and a flicker may be generated.

According to various embodiments wherein, while one image frame is being output, in order that the plurality of first to n-th display modules 110-1 to 110-n perform dithering by using the same dither mask, the at least one processor 120 may transmit reference signals to each display module of the plurality of first to n-th display modules 110-1 to 110-n, and each display module of the plurality of first to n-th display modules 110-1 to 110-n may identify a dither mask corresponding to the reference signal, and may perform dithering by using the identified dither mask.

The plurality of first to n-th display modules 110-1 to 110-n, according to the disclosure, may perform dithering by using the same dither mask while one image frame is being output, and thus flickers may not be generated on the boundaries from among the plurality of first to n-th display modules 110-1 to 110-n, and as a result, grayscale linearity may be improved, when compared to related display apparatuses.

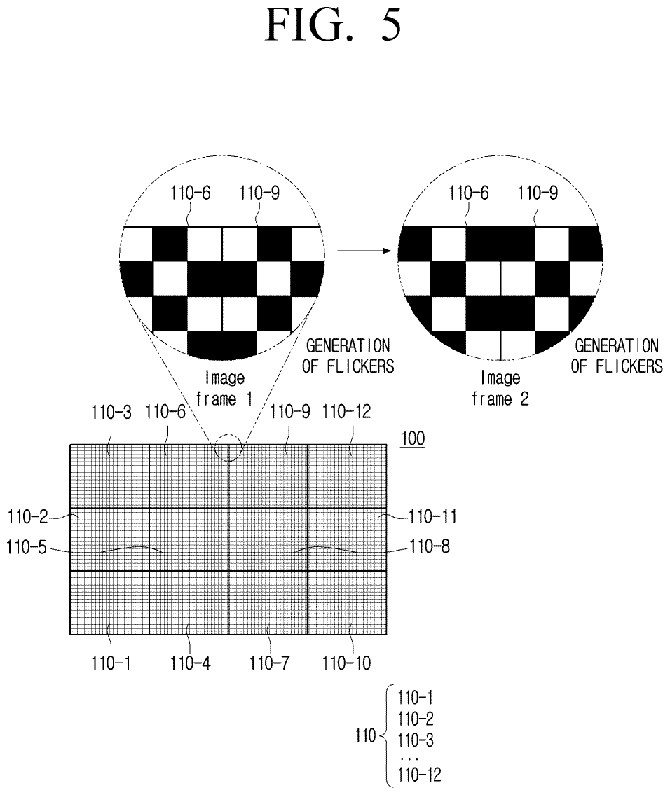

FIG. 5 is a diagram for illustrating flickers due to dither masks, according to an embodiment of the disclosure.

If the plurality of first to n-th display modules 110-1 to 110-n perform dithering by using different dither masks, and not the same dither mask, flickers may be generated while a plurality of image frames are being output, for example, when the image frame is converted.

Referring to FIG. 5, the sixth display module 110-6 and the ninth display module 110-9 may perform dithering by using different dither masks, and thus a flicker may be generated when the image frame 1 is converted to the image frame 2.

The dither masks used by the plurality of first to n-th display modules 110-1 to 110-n for dithering may be changed in units of image frames, and thus, a flicker may not be generated when the image frame output by the display panel 110 is converted.

As shown in FIGS. 4 and 5, the first dither mask may be a four (4) pixel dither mask that may perform dithering such that the pixels on the upper left end and the lower right end from among the four (4) pixels may be output as relatively dark pixels, and the pixels on the upper right end and the lower left end may be output as relatively bright pixels. The second dither mask may be a four (4) pixel dither mask that may perform dithering such that the pixels on the upper left end and the lower right end from among the four (4) pixels may be output as relatively bright pixels, and the pixels on the upper right end and the lower left end may be output as relatively dark pixels. However, this is merely an example, and the present disclosure is not limited thereto.

For example, a dither mask may include at least two color pixels, and include a dither pattern of a predetermined size. The number of colors (e.g., black, white, or gray) constituting the dither mask or the composition of the colors, the number of pixels constituting the dither mask, the dither pattern, or the like may be changed variously.

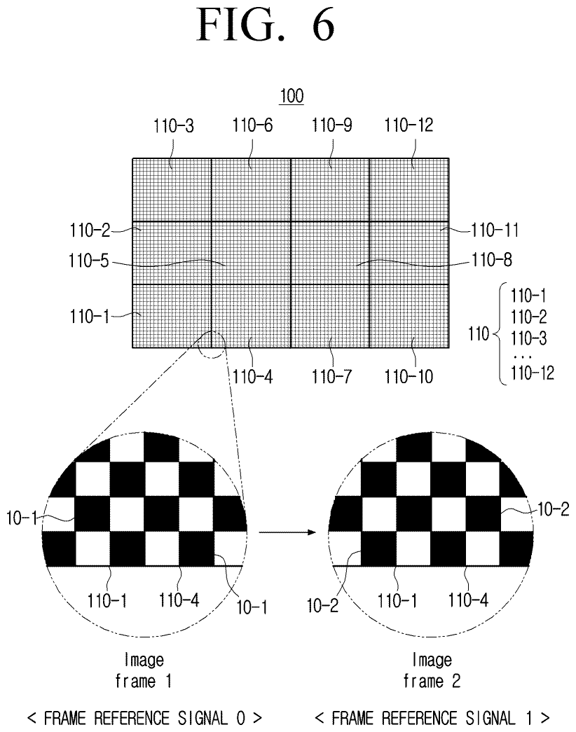

FIG. 6 is a diagram for illustrating a reference signal, according to an embodiment of the disclosure.

Referring to FIG. 6, the at least one processor 120 may sequentially transmit a plurality of image frames constituting an image to each display module of the plurality of first to n-th display modules 110-1 to 110-n. The at least one processor 120 may also transmit reference signals corresponding to each image frame of the plurality of image frames.

For example, the at least one processor 120 may transmit the first image frame from among the plurality of image frames to each display module of the plurality of first to n-th display modules 110-1 to 110-n, and may also transmit a reference signal corresponding to the first image frame (e.g., a frame reference signal 0, hereinafter referred to as a first reference signal) together.

When the first image frame and the first reference signal are received, the controller included in each display module of the plurality of first to n-th display modules 110-1 to 110-n may apply the first dither mask 10-1 corresponding to the first reference signal, from among the first dither mask 10-1 and the second dither mask 10-2, to the first image frame.

For example, the controller included in each display module of the plurality of first to n-th display modules 110-1 to 110-n may apply the first dither mask 10-1 to some corresponding images (or, a partial image) in the first image frame, and subsequently output the frame.

The at least one processor 120 may transmit the second image frame from among the plurality of image frames to each display module of the plurality of first to n-th display modules 110-1 to 110-n, and may also transmit a reference signal corresponding to the second image frame (e.g., a frame reference signal 1, hereinafter referred to as a second reference signal) together.

According to an embodiment, when the second image frame and the second reference signal are received, the controller included in each display module of the plurality of first to n-th display modules 110-1 to 110-n may apply the second dither mask 10-2 corresponding to the second reference signal, from among the first dither mask 10-1 and the second dither mask 10-2, to the second image frame.

For example, the controller included in each display module of the plurality of first to n-th display modules 110-1 to 110-n may apply the second dither mask 10-2 to some corresponding images (or, a partial image) in the second image frame, and subsequently output the frame.

According to an embodiment, each display module of the plurality of first to n-th display modules 110-1 to 110-n may alternatingly (or, alternately) apply the first dither mask 10-1 and the second dither mask 10-2 to a plurality of image frames sequentially received from the at least one processor 120 in units of image frames.

Referring to FIG. 6, according to an embodiment, the first display module 110-1 from among the plurality of first to n-th display modules 110-1 to 110-n may perform dithering by using the first dither mask 10-1, and the fourth display module 110-4 adjacent to the first display module 110-1 may also perform dithering by using the first dither mask 10-1.

While any one image frame is being output, the plurality of first to n-th display modules 110-1 to 110-n may perform dithering by using the same dither mask, and thus flickers may not be generated on the boundaries among the display modules.

In addition, the dither mask used by the first display module 110-1 and the fourth display module 110-4 for dithering may be changed in units of image frames, and as a result, a flicker may not be generated when the image frame output by the display panel 110 is converted from the image frame 1 to the image frame 2.

While any one image frame is being output, if the dither masks used by each display module of the plurality of first to n-th display modules 110-1 to 110-n for dithering are different, the at least one processor 120, according to an embodiment of the disclosure, may re-count the number of transmission of image frames by using the frame counter. Accordingly, the at least one processor 120 may re-obtain the reference signals.

The at least one processor 120 may transmit the image frames and the re-obtained reference signals to each display module of the plurality of first to n-th display modules 110-1 to 110-n, and each display module of the plurality of first to n-th display modules 110-1 to 110-n may perform dithering by using the same dither mask while any one image frame received from the at least one processor 120 is being output.

While any one display module is performing dithering by using the first dither mask 10-1, if another display module adjacent to the any one display module performs dithering by using the second dither mask 10-2, the controller included in the any one display module from among the plurality of first to n-th display modules 110-1 to 110-n may re-identify a dither mask corresponding to any one image frame based on the reference signal.

For example, if any one display module 110 is performing dithering by using a different dither mask from another display module located near, the any one display module may re-identify a dither mask based on the reference signal. Subsequently, the any one display module may apply the re-identified dither mask to a partial image corresponding to any one image frame, and then output the frame.

According to various embodiments of the disclosure, the plurality of first to n-th display modules 110-1 to 110-n may perform dithering by using the same dither mask, and may change the dither mask in units of frames, and as a result, a flickering effect that may be generated on the boundaries of the plurality of first to n-th display modules 110-1 to 110-n, and/or flickers that may be generated when the image frame is converted, may be prevented and/or reduced, when compared to related display apparatuses.

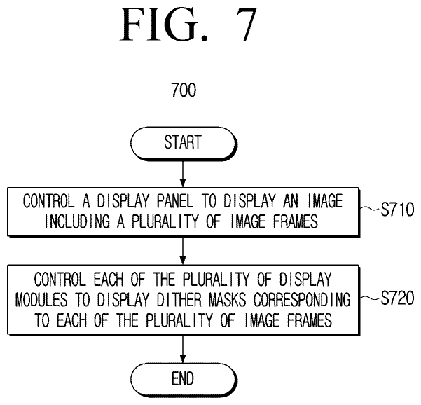

FIG. 7 is a flow chart for illustrating a control method of a display apparatus, according to an embodiment of the disclosure.

Referring to FIG. 7, the control method 700 of the display apparatus 100 may include controlling a plurality of display modules to display an image including a plurality of image frames (operation S710).

Each display module of the plurality of display modules may be controlled to display dither masks corresponding to each image frame of the plurality of image frames (operation S720).

Operation S720 of controlling the display of the dither masks may include operations to, based on receiving any one image frame from among the plurality of image frames, identify a dither mask corresponding to the any one image frame by each display module of the plurality of display modules, and display a partial image corresponding to the any one image frame and the identified dither mask.

The control method 700, according to an embodiment of the disclosure, may further include operations to sequentially transmit the plurality of image frames and reference signals corresponding to each image frame of the plurality of image frames to each display module of the plurality of display modules, and the operation of identifying the dither mask may include operations to, based on receiving the any one image frame and a reference signal corresponding to the any one image frame, identify the dither mask on the basis of the reference signal.

The operations of identifying the dither mask, according to an embodiment of the disclosure, may include operations to identify the dither mask corresponding to the reference signal from among the plurality of dither masks by controllers included in each display module of the plurality of display modules.

The plurality of dither masks, according to an embodiment, may include a first temporal dither mask and a second temporal dither mask, and the control method 700, according to an embodiment, may include operations to, based on receiving a first image frame from among the plurality of image frames and a first reference signal corresponding to the first image frame, apply the first dither mask corresponding to the first reference signal to a partial image corresponding to the first image frame by each display module of the plurality of controllers, and based on receiving a second image frame from among the plurality of image frames and a second reference signal corresponding to the second image frame, apply the second dither mask corresponding to the second reference signal to a partial image corresponding to the second image frame by each display module of the plurality of controllers.

The reference signal, according to an embodiment of the disclosure, may correspond to information on the number of times that the any one processor transmitted the image frames constituting the image to each display module of the plurality of display modules, and the control method 700, according to an embodiment, may include operations to alternatingly apply the first dither mask and the second dither mask according to the information on the number of times by each display module of the plurality of controllers.

The control method 700, according to an embodiment of the disclosure, may further include operations to, while a first display module is displaying a first dither mask, if a second display module adjacent to the first display module displays a second dither mask, re-identify a dither mask corresponding to any one image frame based on the reference signal by a first controller included in the first display module from among the plurality of display modules.

The control method 700, according to an embodiment of the disclosure, may further include operations to display a partial image corresponding to the any one image frame and the re-identified dither mask by the first controller.

The dither mask, according to an embodiment, may include at least two color pixels, and may have a dither pattern of a predetermined size.

Each of the plurality of display modules, according to an embodiment of the disclosure, may operate by using a passive matrix method.

Various embodiments of the present disclosure may be applied not only to a display apparatus, but also to electronic apparatuses of all types that include a display functionality.

Various embodiments of the present disclosure may be implemented in a recording medium that is readable by a computer or an apparatus similar thereto, by using software, hardware, or a combination thereof. In some cases, the embodiments described in the present disclosure may be implemented as a processor itself. According to implementation by software, the embodiments such as procedures and functions described in the present disclosure may be implemented as separate software modules. Each of the software modules may perform one or more functions and operations described in the present disclosure.

Computer instructions for performing processing operations of an electronic apparatus, according to the aforementioned various embodiments of the disclosure, may be stored in a non-transitory computer-readable medium. Computer instructions stored in such a non-transitory computer-readable medium may make the processing operations at the electronic apparatus, according to the aforementioned various embodiments, performed by a specific machine, when the instructions are executed by the processor of the specific machine.

A non-transitory computer-readable medium refers to a medium that stores data semi-permanently, and is readable by machines, but not a medium that stores data for a short moment such as a register, a cache, and memory. Examples of a non-transitory computer-readable medium may include, but not be limited to, a compact disc (CD), a digital versatile disc (DVD), a hard disk, a blue-ray disk, a universal serial bus (USB), a memory card, a read-only memory (ROM), or the like.

While various embodiments of the disclosure have been shown and described, the present disclosure is not limited to the aforementioned embodiments, and it is to be apparent that various modifications may be made by those having ordinary skill in the technical field to which the disclosure belongs, without departing from the scope of the disclosure as claimed by the appended claims. Further, it is intended that such modifications are not to be interpreted independently from the technical idea or prospect of the disclosure.

What is claimed is:

1. A display apparatus, comprising:
a display panel comprising a plurality of display modules;
one or more processors comprising processing circuitry; and
memory storing instructions,
wherein the instructions, when executed by the one or more processors individually or collectively, cause the display apparatus to:
display, using the display panel, an image comprising a plurality of image frames, and
display, on each display module of the plurality of display modules, a dither mask from among a plurality of dither masks corresponding to an image frame of the plurality of image frames, and
wherein each display module of the plurality of display modules is configured to:
receive the image frame of the plurality of image frames,
identify, based on receipt of the image frame, the dither mask corresponding to the image frame, and
display a partial image corresponding to the image frame and the dither mask.

2. The display apparatus of claim 1, wherein the instructions, when executed by the one or more processors individually or collectively, further cause the display apparatus to:
sequentially transmit, to the plurality of display modules, the plurality of image frames and a plurality of reference signals corresponding to the plurality of image frames, and
wherein each display module of the plurality of display modules is further configured to:
receive the plurality of image frames and the plurality of reference signals corresponding to the plurality of image frames, and
identify the dither mask based on a reference signal from among the plurality of reference signals corresponding to the image frame.

3. The display apparatus of claim 2, wherein each display module of the plurality of display modules comprises:
a controller configured to control the display module, and
wherein the controller is further configured to:
identify, based on receipt of the reference signal from the one or more processors, the dither mask corresponding to the reference signal from among the plurality of dither masks, and
display the partial image corresponding to the image frame and the dither mask.

4. The display apparatus of claim 3, wherein the plurality of dither masks comprise:
a first temporal dither mask; and
a second temporal dither mask, and
wherein the controller is further configured to:
apply, based on receiving a first image frame from among the plurality of image frames and a first reference signal from among the plurality of reference signals corresponding to the first image frame, the first temporal dither mask corresponding to the first reference signal to a first partial image corresponding to the first image frame, and
apply, based on receiving a second image frame from among the plurality of image frames and a second reference signal from among the plurality of reference signals corresponding to the second image frame, the second temporal dither mask corresponding to the second reference signal to a second partial image corresponding to the second image frame.

5. The display apparatus of claim 4, wherein the plurality of reference signals comprise information indicating a number of times that the plurality of image frames have been transmitted to the plurality of display modules, and
wherein the controller is further configured to:
alternatingly apply at least one of the first temporal dither mask or the second temporal dither mask based on the information indicating the number of times.

6. The display apparatus of claim 4, wherein a first controller of a first display module from among the plurality of display modules is further configured to:
re-identify, based on a second display module adjacent to the first display module displaying the second temporal dither mask while the first display module is displaying the first temporal dither mask, the dither mask corresponding to the image frame based on the reference signal to obtain a re-identified dither mask.

7. The display apparatus of claim 6, wherein the first controller is further configured to:
display the partial image corresponding to the image frame and the re-identified dither mask.

8. The display apparatus of claim 1, wherein the dither mask comprises at least two color pixels, and
wherein the dither mask comprises a dither pattern of a predetermined size.

9. The display apparatus of claim 1, wherein each display module of the plurality of display modules operates based on a passive matrix method.

10. A control method to by performed by a display apparatus, the control method comprising:
displaying, using a display panel of the display apparatus, an image comprising a plurality of image frames, the display panel comprising a plurality of display modules; and
displaying, on each display module of the plurality of display modules, a dither mask from among a plurality of dither masks corresponding to an image frame of the plurality of image frames,
wherein the displaying of the dither mask comprises:
receiving, by each display module of the plurality of display modules, the image frame of the plurality of image frames;
identifying, by each display module of the plurality of display modules, the dither mask corresponding to the image frame, based on the receiving of the image frame; and
displaying, by each display module of the plurality of display modules, a partial image corresponding to the image frame and the dither mask.

11. The control method of claim 10, further comprising:
sequentially transmitting, to the plurality of display modules, the plurality of image frames and a plurality of reference signals corresponding to the plurality of image frames,
wherein the identifying of the dither mask comprises:
receiving, by each display module of the plurality of display modules, the plurality of image frames and the plurality of reference signals corresponding to the plurality of image frames; and
identifying the dither mask based on a reference signal from among the plurality of reference signals corresponding to the image frame.

12. The control method of claim 11, wherein the plurality of dither masks comprise:
a first temporal dither mask; and
a second temporal dither mask, and
wherein the control method further comprises:
applying, by each display module of the plurality of display modules, based on receiving a first image frame from among the plurality of image frames and a first reference signal from among the plurality of reference signals corresponding to the first image frame, the first temporal dither mask corresponding to the first reference signal to a first partial image corresponding to the first image frame; and
applying, by each display module of the plurality of display modules, based on receiving a second image frame from among the plurality of image frames and a second reference signal from among the plurality of reference signals corresponding to the second image frame, the second temporal dither mask corresponding to the second reference signal to a second partial image corresponding to the second image frame.

13. The control method of claim 12, wherein the plurality of reference signals comprise information indicating a number of times that the plurality of image frames have been transmitted to the plurality of display modules, and
wherein the control method further comprises:
alternatingly applying, by each display module of the plurality of display modules, at least one of the first temporal dither mask or the second temporal dither mask based on the information indicating the number of times.

14. The control method of claim 12, wherein the plurality of display modules comprise a first display module and a second display module adjacent to the first display module, and
wherein the control method further comprises:
re-identifying, by the first display module, the dither mask corresponding to the image frame based on the reference signal to obtain a re-identified dither mask, based on the second display module displaying the second temporal dither mask while the first display module is displaying the first temporal dither mask.

15. The control method of claim 14, further comprising:
displaying, by the first display module, the partial image corresponding to the image frame and the re-identified dither mask.

16. The control method of claim 10, wherein the dither mask comprises at least two color pixels, and
wherein the dither mask comprises a dither pattern of a predetermined size.

17. The control method of claim 10, further comprising:
operating each display module of the plurality of display modules based on a passive matrix method.

18. A non-transitory computer-readable storage medium storing a computer-executable program for executing a control method that, when executed by at least one processor of a display apparatus, causes the display apparatus to:
display, using a display panel of the display apparatus, an image comprising a plurality of image frames, the display panel comprising a plurality of display modules; and
display, on each display module of the plurality of display modules, a dither mask from among a plurality of dither masks corresponding to an image frame of the plurality of image frames, and
wherein the computer-executable program, when executed by the at least one processor, further cause the display apparatus to:
receive, by each display module of the plurality of display modules, the image frame of the plurality of image frames;
identify, by each display module of the plurality of display modules, the dither mask corresponding to the image frame, based on the receiving of the image frame; and
display, by each display module of the plurality of display modules, a partial image corresponding to the image frame and the dither mask.

19. The non-transitory computer-readable storage medium of claim 18, wherein the computer-executable program, when executed by the at least one processor, further cause the display apparatus to:
sequentially transmit, to the plurality of display modules, the plurality of image frames and a plurality of reference signals corresponding to the plurality of image frames;
receive, by each display module of the plurality of display modules, the plurality of image frames and the plurality of reference signals corresponding to the plurality of image frames; and
identify the dither mask based on a reference signal from among the plurality of reference signals corresponding to the image frame.

20. The non-transitory computer-readable storage medium of claim 19, wherein the plurality of dither masks comprise:
a first temporal dither mask; and
a second temporal dither mask, and
wherein the computer-executable program, when executed by the at least one processor, further cause the display apparatus to:
apply, by each display module of the plurality of display modules, based on receipt of a first image frame from among the plurality of image frames and a first reference signal from among the plurality of reference signals corresponding to the first image frame, the first temporal dither mask corresponding to the first reference signal to a first partial image corresponding to the first image frame; and
apply, by each display module of the plurality of display modules, based on receipt of a second image frame from among the plurality of image frames and a second reference signal from among the plurality of reference signals corresponding to the second image frame, the second temporal dither mask corresponding to the second reference signal to a second partial image corresponding to the second image frame.
